(19) United States
(12) Patent Application Publication
(10) Pub. No.: US 2004/0078690 A1
(43) Pub. Date: Apr. 22, 2004

(54) Program counter trace system, program counter trace method, and semiconductor device

(76) Inventor: Yasuo Kohashi, Fukuoka (JP)

Correspondence Address: PARKHURST & WENDEL, L.L.P., 1421 PRINCE STREET, SUITE 210, ALEXANDRIA, VA, 22314-2805, US

(21) Appl. No.: 10/276,908

(22) PCT Filed: May 30, 2001
(86) PCT No.: PCT/JP01/04548

(30) Foreign Application Priority Data
May 30, 2000 (JP) 2000-159873

(51) Int. Cl. G06F 11/00

(52) U.S. Cl. 714/38

(57) ABSTRACT

The present invention provides a program counter trace system which requires fewer external terminals from a processor to a debugging tool in cases where an external debugger and the processor are operated at the same frequency to perform debugging, and performs PC trace efficiently with a simple structure.

The processor includes a means for generating, on the basis of a difference between a program counter value of the preceding cycle and a present program counter value in each cycle, trace status information indicating one of: a status corresponding to a head of serial data of the program counter value, a status indicating that displacement from the program counter value is “0”, a status indicating that displacement from the program counter value is “1”, and an error occurrence status, and branch information indicating that the program counter value is branched; a means for converting the program counter value into serial data only when the branch information indicates a branch status and outputting the serial data; and a means for outputting a trace clock having the same frequency as that of an operation clock of the processor, and the debugging tool receives the trace status information and the trace serial data in synchronization with the trace clock.

### TECHNICAL FIELD

The present invention relates to a program counter trace system and a program counter trace method for debugging a processor that operates in accordance with a program.

### BACKGROUND ART

In system development by employing a processor that operates in accordance with a program, it is important to keep track of operation statuses of the processor to efficiently perform system debugging. Particularly, analyzing history records of lines of a program which is being executed by the processor (program counter trace) is effective, and thus processors containing a trace circuit for a program counter have been developed. It is assumed hereinafter that the program counter is referred to as “PC”, and the program counter trace is referred to as “PC trace”.

In a conventional PC trace method, PC values of a processor are outputted as they are as 16-bit parallel data directly to an external terminal, or PC values are converted into serial data to be outputted.

In addition, as disclosed in Japanese Published Patent Application No. Hei.10-275092, there is a method in which PC values are converted into variable-length packets to be outputted.

FIG. 13 is a diagram illustrating a structure of a PC trace system that converts PC values into packets and outputs the obtained packets. In FIG. 13, reference numeral 1300 denotes a processor core that operates in accordance with a program, numeral 1301 denotes an operation clock for the processor core 1300, numeral 1302 denotes a program counter value that indicates an execution line of a program which is being executed by the processor core 1300, numeral 1303 denotes a trace packet generation unit for converting the program counter value 1302 into a packet and converting the obtained packet into serial data, numeral 1304 denotes a packet buffer unit that temporarily holds the trace packet outputted from the trace packet generation unit 1303 until it is outputted outside the processor, numeral 1305 denotes a debugging module which is constituted by the trace packet generation unit 1303 and the packet buffer unit 1304, numeral 1306 denotes a processor which is constituted by the processor core 1300 and the debugging module 1305, numeral 1307 denotes a trace clock for outputting the trace packet that has been temporarily stored in the packet buffer unit 1304 to the outside of the processor 1306, numeral 1308 denotes a trace packet start signal at a time when the trace packet that has been temporarily stored in the packet buffer unit 1304 is outputted to the outside of the processor 1306, numeral 1309 denotes trace serial data which is outputted as serial data from the packet buffer unit 1304 in synchronization with the trace clock 1307, numeral 1310 denotes a debugging control that controls a trace storing circuit 1311 in accordance with the trace clock 1307 and the trace status 1308 which are outputted from the processor 1306, numeral 1311 denotes a trace storing circuit that restores a variable-length packet corresponding to the trace serial data 1309 to an original PC value under control of the debugging control 1310, and stores the restored PC value in a trace memory 1312, numeral 1312 denotes a trace memory that stores the PC value which has been restored by the trace storing circuit, numeral 1313 denotes a communication interface that controls communication between the debugging control 1310 or the trace storing circuit 1311, and a personal computer 1315, numeral 1314 denotes a debugging tool including the debugging control 1310, the trace storing circuit 1311 and the communication I/F 1313, numeral 1315 denotes a personal computer that displays a source of the program which is being executed by the processor, and shows a line corresponding to the PC value obtained from the debugging tool 1314, and numeral 1316 denotes a debugger that generates contents to be displayed on the personal computer.

A program counter trace operation of the conventional program counter trace system that is constructed as mentioned above will be described with reference to FIG. 13.

In FIG. 13, a PC value 1302 which is outputted from the processor core 1300 is converted into a packet by the trace packet generation unit. Here, a packet is generated by adding a packet header to the PC value itself or PC trace information such as an encoded difference between a PC value of the immediately preceding cycle and the present PC value. A packet having a shorter code length is assigned to frequently generated PC trace information. The generated packet is temporarily stored in the packet buffer 1304. The role of the packet buffer 1304 is, when the operation frequency of the processor core is high and the operation of the debugging tool is performed at low speeds, and when a group of packets which are outputted by the trace packet generation unit to the packet buffer and a group of packets which are read from the packet buffer by the debugging tool have a relationship: the former group>the latter group, to temporarily hold overflowing packets of the former group, thereby preventing lack of the former packets.

FIG. 14 is a timing chart showing states of the trace status 1308 indicating a head of a packet and the trace serial data 1309 corresponding to variable-length packets outputted as serial data, which are outputted in synchronization with the trace clock 1307 in FIG. 13. As shown in FIG. 14, a packet comprises a packet header and packet data, and the trace status shows starts of packets A, B and C. As the packet data has a variable length, packet data of longer code lengths are frequently generated in cases where trace information having a lower frequency often occurs, and when a packet which cannot be absorbed even by the packet buffer 1304 is generated, a packet indicating a packet buffer overflow is outputted after the packet buffer overflow has been overcome.

On the other hand, the trace serial data (packet data) which has been read by the external debugging tool is restored to an original PC value and then stored in the trace memory. When a PC trace stopping operation is performed here by the debugging tool to analyze the program that is being executed by the processor, history records of already passed PC values going back from a PC value at a time when the PC trace has been stopped are stored adaptively to a capacity of the trace memory 1312. The debugger 1316 that operates in the personal computer 1315 reads the history records, and displays the same in combination with a program source code, thereby enabling the analysis of the program operation. Here, more PC values can be stored as the trace memory 1312 has a larger capacity, and accordingly the analysis of the program can be performed more easily.

The conventional program counter trace system has following problems.

Initially, in a system that outputs PC values of the processor as they are as parallel data, when the number of bits corresponding to the PC values is increased, the number of external terminals is correspondingly increased, and thus a chip size is increased, thereby preventing miniaturization of the system on which the chip is mounted.

In addition, in the cases where the PC values of the processor are outputted as they are as serial data, when assuming that a processor operation frequency and a debugger operation frequency are the same, the substantial execution speed of the processor is decreased and accordingly the debugging efficiency is deteriorated, because the processor is operated or temporarily stopped in accordance with the debugger.

Thus, in the method as disclosed in Japanese Published Patent Application No. Hei.10-275092, trace information is converted into packets and outputted as serial data. According to this method, however, it is necessary that a high-speed processor should include a packet buffer for absorbing a difference between an output speed at which the trace packet generation unit in the processor outputs packets and a receiving speed at which the external debugger receives packets, and accordingly the chip costs and power consumption are more increased as the capacity of the buffer is more increased.

In addition, according to this prior art, the packet conversion is performed by assigning a code having a shorter length to the trace information having a higher frequency, to reduce the amount of packets to be outputted. However, the conversion circuit becomes rather complicated, and accordingly the circuit scale is adversely increased.

Further, when the buffer nearly overflows with packets, the processor is stopped and, also in this case, the substantial execution speed of the processor is unfavorably decreased, whereby the debugging efficiency is deteriorated.

On the other hand, as the debugger analyzes the program within a range of PC values which are stored in the trace memory, a larger capacity of the trace memory is required to perform efficient debugging, thereby increasing the costs of the debugger.

The present invention is made to solve the above-mentioned problems, and this invention has for its object to provide a PC trace system, a PC trace method, and a semiconductor device, which can reduce the number of external terminals of a processor to a debugging tool, and dispense with a mounted buffer like a packet buffer, as well as can use a smaller capacity of a trace memory in the debugging tool, and can perform PC trace efficiently, without temporarily stopping the processor, when an external debugger and the processor can operate at the same frequency.

### DISCLOSURE OF THE INVENTION

To solve the above-mentioned problems, according to the present invention (claim 1), there is provided a program counter trace system which operates a processor and an external debugging tool at a same frequency, to perform program counter trace for debugging, in which the processor includes: a trace flag generation unit for holding a program counter value which is outputted from a processor core that executes a program, in each operation cycle of the processor, obtaining a difference between a previous program counter value which is held and a present program counter value, and generating on the basis of the difference in each cycle, first and second trace status information indicating that a present status is one of: a status corresponding to a head of serial data of a program counter value; a status in which displacement from the previous program counter value is “0”; a status in which displacement from the previous program counter value is “1”; and an error occurrence status indicating that serial data outputting occurs in a period which overlaps an output period of the serial data, and branch information indicating that the program counter value is branched; a parallel/serial conversion unit for converting a program counter value into serial data only when the branch information generated by the trace flag generation unit indicates a branch status, and outputting the serial data as trace serial data; and a trace clock generation unit for outputting a trace clock having the same frequency as that of an operation clock for the processor, and the debugging tool receives the trace status information and the trace serial data in synchronization with the trace clock.

Therefore, in cases where an external debugging tool and a processor are to be operated at the same frequency, the amount of trace information can be reduced by a simple circuit, the trace information can be outputted through a small number (four) of external terminals, and further it is not required to mount a memory such as a packet buffer on the processor, thereby reducing chip costs and power consumption.

According to the present invention (claim 2), in the program counter trace system of claim 1, the processor includes a control means for controlling the trace flag generation unit, the parallel/serial conversion unit, and the trace clock generation unit to operate only when the processor core is operating in a debugging mode, while stopping operations of the trace flag generation unit, the parallel/serial conversion unit, and the trace clock generation unit when the processor is stopping in the debugging mode or in cases other than the debugging mode.

Therefore, the normal power consumption at the completion of debugging can be further reduced.

According to the present invention (claim 3), in the program counter trace system of claim 1, the debugging tool includes: a first data shift unit for converting the first trace status information into parallel data; a second data shift unit for converting the second trace status information into parallel data; a third data shift unit for converting the trace serial data into parallel data; a data selection unit for successively selecting one of the parallel output data which is outputted from the first data shift unit, the parallel output data which is outputted from the second data shift unit, and the parallel output data which is outputted from the third data shift unit, and outputting the selected parallel output data; a trace FiFo for storing the parallel output data which is selected by the data selection unit; and a FiFo control unit for outputting capacity information of the trace FiFo and controlling writing/reading capacity information of the trace FiFo.

Therefore, parallel trace data which are read from the trace FiFo are stored in a large capacity hard disk via the communication interface in accordance with the capacity information from the trace FiFo control unit, whereby a smaller capacity of a storage means can be provided in the debugging tool.

According to the present invention (claim 4), in the program counter trace system of claim 1, the debugging tool includes: a first data shift unit for converting the first and second trace status information into parallel data; a first trace FiFo for storing the parallel output data from the first data shift unit; a first FiFo control unit for outputting capacity information of the first trace FiFo and controlling writing/reading of data into/from the first trace FiFo; a second data shift unit for converting the trace serial data into parallel data only when the first and second trace status information indicates an effective trace serial data output period; a second trace FiFo for storing the parallel output data from the second data shift unit; and a second FiFo control unit for outputting capacity information of the second trace FiFo and controlling writing/reading of data into/from the second trace FiFo.

Therefore, only necessary trace information is stored in the second trace FiFo, whereby the amount of information that is stored in the trace FiFo is reduced, and accordingly the capacity of the trace FiFo can be reduced.

According to the present invention (claim 5), in the program counter trace system of claim 1, the debugging tool includes: a first data shift unit for converting the first and second trace status information into parallel data, and adding to the parallel data a flag indicating that the parallel data is trace status information; a second data shift unit for converting the trace serial data into parallel data and adding thereto a flag indicating that the parallel data is trace serial data, only when the first and second trace status information indicates an effective trace serial data output period; a data selection unit for selecting the parallel output data from the first data shift unit when parallel conversion of the first data shift unit has been completed, while selecting the parallel output data from the second data shift unit when parallel conversion of the second data shift unit has been completed; a trace FiFo for storing the parallel output data which is selected by the data selection unit; and a FiFo control unit for outputting capacity information of the trace FiFo and controlling writing/reading of data into/from the trace FiFo.

Therefore, the trace status information and necessary trace serial data can be stored in one trace FiFo, whereby the number of trace FiFos which are mounted on the debugging tool can be reduced, as well as the capacity of the trace FiFo can be reduced.

According to the present invention (claim 6), there is provided a program counter trace method for operating a processor and an external debugger tool at a same frequency, and performing program counter trace for debugging, in which: the processor holds a program counter value which is outputted from a processor core that executes a program in each operation cycle of the processor, obtains a difference between a previous program counter value that is held and a present program counter value, and generates on the basis of the difference in each cycle, first and second trace status information indicating that a present status is one of: a status corresponding to a head of serial data of a program counter value; a status in which displacement from the previous program counter value is “0”; a status in which displacement from the previous program counter value is “1”; and an error occurrence status indicating that serial data outputting occurs in a period that overlaps an output period of the serial data, and branch information indicating that the program counter value is branched; the processor converts a program counter value into serial data only when the generated branch information indicates a branch status, and outputs the serial data as trace serial data; the processor outputs a trace clock having the same frequency as that of an operation clock of the processor; and the debugging tool receives the trace status information and the trace serial data in synchronization with the trace clock.

Therefore, in cases where an external debugging tool and a processor are operated at the same frequency to perform debugging, the trace information can be outputted from the processor to the external debugging tool through a small number (four) of external terminals, and further it is not required to mount a memory such as a packet buffer on the processor, thereby reducing chip costs and power consumption.

According to the present invention (claim 7), there is provided a semiconductor device which has a processor including a processor core that executes a program, in which the processor includes: a trace flag generation unit for holding a program counter value which is outputted from the processor core that executes the program in each operation cycle of the processor, obtaining a difference between a previous program counter value that is held and a present program counter value, and generating on the basis of the difference in each cycle, first and second trace status information indicating that a present status is one of: a status corresponding to a head of serial data of the program counter value; a status in which displacement from the previous program counter value is “0”; a status in which displacement from the previous program counter value is “1”; and an error occurrence status indicating that serial data outputting occurs in a period that overlaps an output period of the serial data, and branch information indicating that the program counter value is branched; a parallel/serial conversion unit for converting a program counter value into serial data only when the branch information which is generated by the trace flag generation unit indicates a branch status, and outputting the serial data as trace serial data; and a trace clock generation unit for outputting a trace clock having the same frequency as that of an operation clock of the processor.

Therefore, in cases where an external debugging tool and a processor are operated at the same frequency to perform debugging, the trace information can be outputted from the processor to the external debugging tool through a small number (four) of external terminals, and further it is not required to mount a memory such as a packet buffer on the processor, thereby reducing chip costs and power consumption.

### BRIEF DESCRIPTION OF THE DRAWINGS

FIG. 1 is a block diagram illustrating a structure of a program counter trace system according to a first embodiment of the present invention.

FIG. 2 is a block diagram illustrating an internal structure of a trace flag generation unit in the program counter trace system according to the first embodiment.

FIG. 3 is a timing chart showing signals outputted from processor external terminals of the program counter trace system according to the first embodiment.

FIG. 4 is a block diagram illustrating an internal structure of a program counter restoration unit in the program counter trace system according to the first embodiment.

FIG. 5 is a diagram showing a state of data storage in a trace memory of the program counter trace system according to the first embodiment.

FIG. 6 is a block diagram illustrating a structure of a program counter trace system according to a second embodiment of the present invention.

FIG. 7 is a diagram showing a state of data storage in a trace FiFo of the program counter trace system according to the second embodiment.

FIG. 8 is a block diagram illustrating a structure of a program counter trace system according to a third embodiment of the present invention.

FIG. 9 is a diagram showing a state of data storage in a first trace FiFo of the program counter trace system according to the third embodiment.

FIG. 10 is a diagram showing a state of data storage in a second trace FiFo of the program counter trace system according to the third embodiment.

FIG. 11 is a block diagram illustrating a structure of a program counter trace system according to a fourth embodiment of the present invention.

FIG. 12 is a diagram showing a state of data storage in a trace FiFo of the program counter trace system according to the fourth embodiment.

FIG. 13 is a block diagram illustrating a structure of a conventional program counter trace system.

FIG. 14 is a timing chart showing signals outputted from processor external terminals of the conventional program counter trace system.

### BEST MODE FOR CARRYING OUT THE INVENTION

Hereinafter, embodiments of the present invention will be described with reference to the drawings. The embodiments shown here are only exemplary, and the present invention is not limited to these embodiments.

Embodiment 1.

Hereinafter, as PC trace systems in which an external debugger and a processor are operated at the same frequency, a PC trace system that suppresses increases in costs of an LSI and implements program counter trace to analyze an operation of the processor will be described as a first embodiment with reference to the drawings.

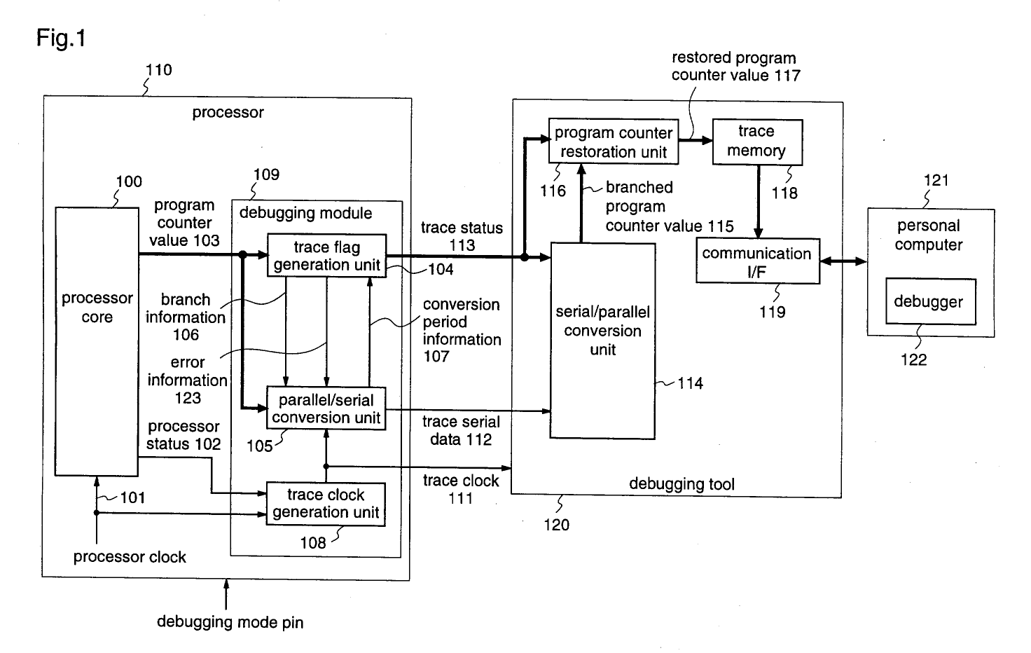

FIG. 1 is a block diagram illustrating a structure of a PC trace system. This PC trace system is constituted by a processor 110, a debugging tool 120, and a personal computer 121.

The processor 110 includes a processor core 100 for executing a program, and a debugging module 109. The processor core 100 executes a program with using a processor clock 101 as an operation clock, and outputs a processor status 102 indicating whether the processor 100 is operating or stopping and a program counter value 103 indicating an execution line of the program which is being executed by the processor core 100.

The debugging module 109 includes a trace flag generation unit 104 for generating, from the program counter value 103 outputted by the processor core 100 and conversion information 107 indicating that the program counter value is being converted into serial data, a trace status signal 113, branch information 106 indicating that the program counter value has been branched, and error information 123 indicating that the program counter value has been branched when the conversion period information is effective; a parallel/serial conversion unit 105 for converting the program counter value 103 into serial data and outputting obtained data to the outside; and a trace clock generation unit 108 for outputting the processor clock 101 as a trace clock only when the processor status 102 indicates that the processor core 100 is operating.

A trace clock 111 outputted by the trace clock generation unit 108, the trace serial data 112 outputted by the parallel/serial conversion unit 105, and the trace status 113 outputted by the trace flag generation unit 104 are inputted to the debugging tool 120. The debugging tool 120 includes a serial/parallel conversion unit 114 for converting the trace serial data 112 into parallel data in synchronization with the trace clock 111 when the trace status 113 indicates the branch of the program counter; a program counter restoration unit 116 for restoring the parallel branched program counter value 115 which is outputted by the serial/parallel conversion unit 114, to an original program counter value on the basis of information corresponding to the trace status 113; a trace memory 118 for storing a restored program counter value 117 which is outputted by the program counter restoration unit 116; and a communication interface 119 for transferring the restored program counter value which is stored in the trace memory 118 in accordance with an instruction of the computer.

The computer 121 that operates a debugger 122 for implementing the program counter trace includes a debugger 122 for analyzing an operation of the processor, in combination with the program counter value that is read from the trace memory 118 via the communication I/F 119 and a source code of the program which is being executed by the processor.

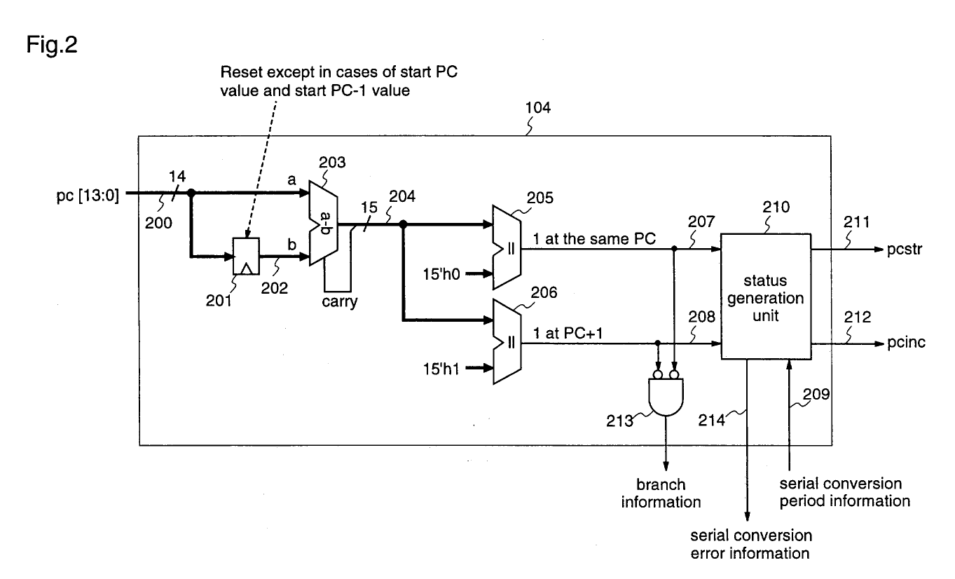

FIG. 2 is a block diagram illustrating an internal structure of the trace flag generation unit 104 shown in FIG. 1. It is assumed here that the number of bits corresponding to a program counter value 200 which is outputted by the processor core 100 is 14 bits, but the number of bits may be 16 bits or 32 bits, depending on the architecture of the processor core 100.

The trace flag generation unit 104 includes a storage unit 201 for holding the program counter value 200 of each cycle in accordance with the processor clock 101; a subtraction unit 203 for obtaining a difference between the program counter value 200 and a program counter value 202 of the immediately preceding cycle, which is stored in the storage unit 201; a comparison unit 205 for setting an output value 207 at “1” when a result value 204 of the subtraction unit 203 is “0”; a comparison unit 206 for setting an output value 208 at “1” when the result value 204 of the subtraction unit 203 is “1”; a status generation unit 210 for generating first trace status information (pcstr) 211 and second trace status information (pcinc) 212 on the basis of conversion period information 209 indicating that the output value 207, the output value 208 and the program counter value are being converted into serial data, in accordance with Table 1; and a logical operation unit 213 for generating branch information that has a value “1” when the output value 207 and the output value 208 are both “0”.

TABLE 1

| Conversion | PC equal | PC + 1 | | |
|---|---|---|---|---|
| period | signal | signal | | |
| information 209 | 207 | 208 | pcstr 211 | pcinc 212 |
| 0 | 0 | 0 | 1 | 0 |
| 0 | 0 | 1 | 0 | 1 |
| 0 | 1 | 0 | 0 | 0 |
| 0 | 1 | 1 | No | No |
| | | | occurrence | occurrence |
| 1 | 0 | 0 | 1 | 1 |
| 1 | 0 | 1 | 0 | 1 |
| 1 | 1 | 0 | 1 | 0 |
| 1 | 1 | 1 | No | No |
| | | | occurrence | occurrence |

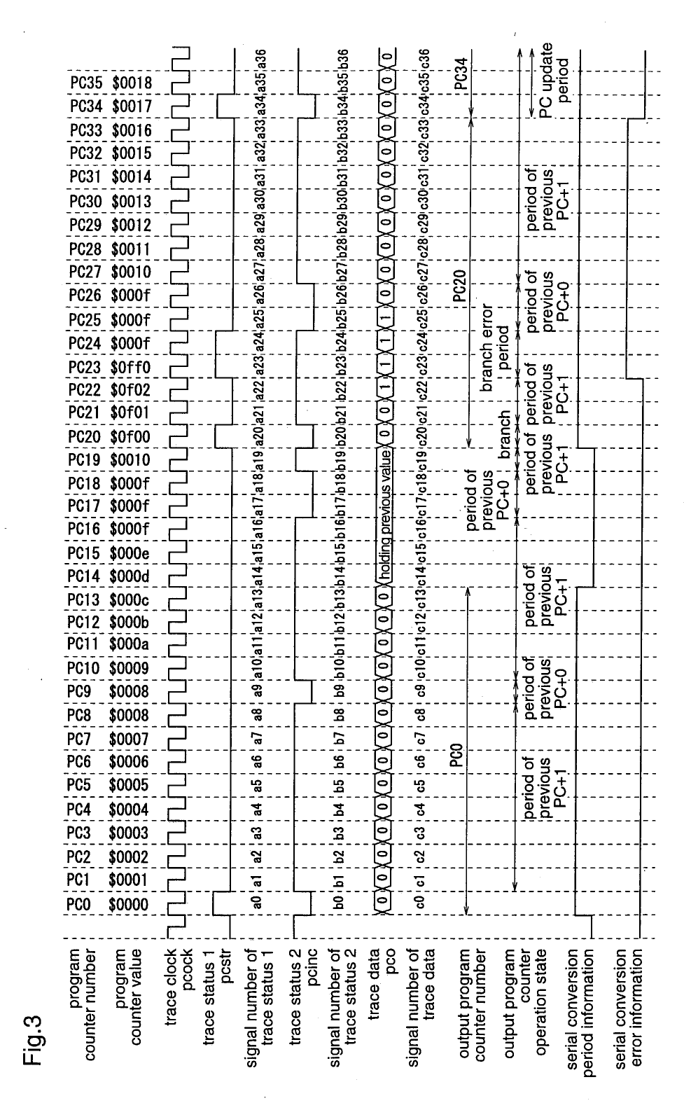

FIG. 3 is a timing chart showing output signals: the trace clock 111 the trace serial data 112 which are outputted from the processor 110 in FIG. 1, and the first trace status 211 and the second trace status 212 in FIG. 2. In FIG. 3, the program counter numbers are serial numbers which are assigned to the program counter values varying with each cycle of the processor clock. The program counter values are counter values of 14 bits which are provided as reference examples. Signals numbers of the trace status 1 are serial numbers which are assigned to respective statuses corresponding to the first trace status. Signal numbers of the trace status 2 are serial numbers which are assigned to respective statuses corresponding to the second trace status. Signal numbers of trace data are serial numbers which are assigned to respective statuses of the trace data. Output program counter numbers are counter numbers corresponding to programs which are outputted as serial data. Output program counter operation status show methods for restoring program counter values in respective cycles. Here, symbol “$” in FIG. 3 designates a number in hexadecimal representation.

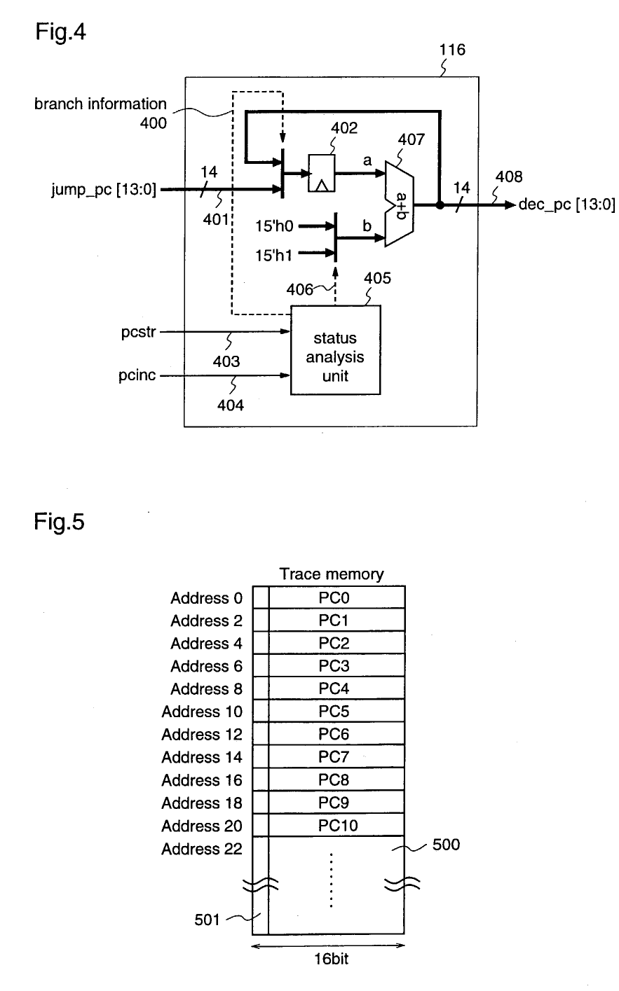

FIG. 4 is a block diagram illustrating an internal structure of the program counter restoration unit 116 in FIG. 1. The program counter restoration unit 116 includes a storage unit 402 for selecting a branched program counter value (jump-pc) 401 that is outputted from the serial/parallel conversion unit 114 or a program counter value which has been restored in the immediately preceding cycle, in accordance with branch information 400 that is generated by a status analysis unit 405 on the basis of a first trace status (pcstr) 403 and a second trace status (pcinc) 404, and holding the selected value; a status analysis unit 405 for generating a selection signal 406 for selecting addition of “0” or “1” to the immediately preceding program counter value, from the first trace status (pcstr) 403 and the second trace status (pcinc) 404; and an addition unit 407 for outputting a restored program counter value (dec_pc) 408 which is obtained by adding an output from the storage unit 402 and “0” or “1” which is selected in accordance with the selection signal 406.

FIG. 5 is a diagram schematically showing a state of storage of restored program counter values which are stored in the trace memory 118 in FIG. 1. In FIG. 5, the restored program counter value which is stored in the trace memory is constituted by a part 500 corresponding to a program counter value of 14 bits, and an error flag 501 indicating that program counter branch has occurred while trace serial data is outputted.

An operation of the PC trace system that is constructed as described above will be described hereinafter.

Initially, assuming that the program counter value 103 in FIG. 1 operates like the program counter values shown in FIG. 3, the parallel/serial conversion unit 105 starts serial conversion of the head program counter value “1$0000”. At the same time, the first trace status pcstr is set at “1” and the second trace status pcinc is set at “0”, to indicates the start of the serial conversion. Then, the program counter value in FIG. 3 shows a status corresponding to the previous program counter value “+1” during 8 cycles and, thus, the first trace status pcstr is set at “0” and the second trace status pcinc is set at “1”. Then, when the processor core executes the same value as the previous program counter value, as the program counter number PC9, it represents a status corresponding to the previous program counter value “+0” and, accordingly, the first trace status pcstr is set at “0” and the second trace status pcinc is set at “0”. Then, again, the status corresponding to the previous program counter value “+1” continues up to the program counter value PC16. Here, the serial outputting of the trace data which has been stared at PC0 stops in 14 cycles corresponding to the number of bits of the program counter value, i.e., at a timing of program counter number PC13. Next, when branch of the program counter occurs at PC20, the first trace status pcstr is set at “1”, and the second trace status pcinc is set at “0”, whereby serial outputting of a program counter value corresponding to the program counter number PC20 is started. This serial outputting takes 14 cycles, i.e., continues up to a timing of program counter number PC 33, while when branch of the program counter occurs as shown in PC23 and PC 24 before the serial outputting is completed, the branch should be informed the external debugger. In this case, the first trace status pcstr is set at “1” and the second trace status pcinc is set at “1”, whereby the external debugger is informed that the branch has occurred during the serial output. Accordingly, the external debugger can proceed to a process for presuming a program counter value that cannot be restored. In FIG. 2, the status generation unit 201 makes effective serial conversion error information 214, i.e., the error information 123 that is outputted from the trace flag generation unit 104 in FIG. 1, when the branch occurs while the serial conversion period information 209 is effective, and makes ineffective the error information 214 at a time when the present serial conversion is finished, as well as sets the first trace status pcstr at “1” and the second trace status pcinc at “0” only at that timing, regardless of the statuses of the signals 207 and 208. In the cases where the error information 123 that is outputted from the trace flag generation unit 104 is effective, when the serial outputting of the program counter value at PC 20 is completed at the time of the program counter number PC33, the parallel/serial conversion unit 105 starts serial outputting of a program counter value corresponding to the present program counter number PC34 from the next clock.

As described above, when the program counter branch occurs at the serial outputting of the program counter value, the program counter value which cannot be restored by the external debugger arises. However, branch within 14 cycles rarely happens when a program that exploits a full processing performance of the processor is created, and accordingly the debugging efficiency is not reduced.

Next, the operation of the debugger 122 in FIG. 1 is described. The debugger 122 stops the operation of the processor and reads a restored program counter value that is stored in the trace memory 118. Then, the debugger checks the restored program counter value against a source code of a program that is executed by the processor, to analyze the operation flow of the program. When there is any program counter value which has not been restored, the debugger compares the program counter value with a source code, thereby presuming a code which is to be executed next by itself. And then, when the presumed code is presented, the user can analyze the program.

When there is information “+1” or “+0” corresponding to displacement from the program counter value which was incapable of restoration, “−1” or “+0” is added to a subsequent program counter value which has been restored, thereby enabling restoration of the program counter value which has not been restored, by an inverse operation. However, when there are successive program counter values which cannot be restored, program counter values up to the temporally latest one can be restored by the inverse operation.

As described above, according to this first embodiment, the processor 110 includes the trace flag generation unit 104 that holds the program counter value 103 outputted by the processor core 100 that executes the program, in each operation cycle of the processor, obtains a difference between a previous program counter value that is held and a present program counter value, and generates on the basis of the obtained difference in each cycle, the first and second trace status information 113 indicating that the present status is one of: a status corresponding to a head of serial data of the program counter value, a status in which displacement from the previous program counter value is “0”, a status in which displacement from the previous program counter value is “1”, and an error occurrence status indicating that serial data outputting has occurred in a period that overlaps an output period of the previous serial data, and the branch information 106 indicating that the program counter value has been branched; the parallel/serial conversion unit 105 that converts a program counter value into serial data only when the branch information that is generated by the trace flag generation unit 104 indicates a branch status, and outputs the trace serial data 112; and the trace clock generation unit 108 that outputs the trace clock 111 having the same frequency as the operation clock of the processor, and the debugging tool 120 receives the trace status information 113 and the trace serial data 112 in synchronization with the trace clock 111. Therefore, the amount of trace information can be reduced with a simpler circuit, and the trace information can be outputted through fewer (four) external terminals. Further, it is not required to mount a memory such as a packet buffer on the processor, thereby reducing the chip costs and power consumption.

In this first embodiment, it is possible to perform control so that the trace flag generation unit, the parallel/serial conversion unit, and the trace clock generation unit are operated only when the processor core is operating in the debugging mode, and the operations of the trace flag generation unit, the parallel/serial conversion unit, and the trace clock generation unit are stopped when the processor core is stopping or in cases other than the debugging mode. When the control is performed in this way, the normal power consumption at the completion of the debugging can be further reduced.

Embodiment 2.

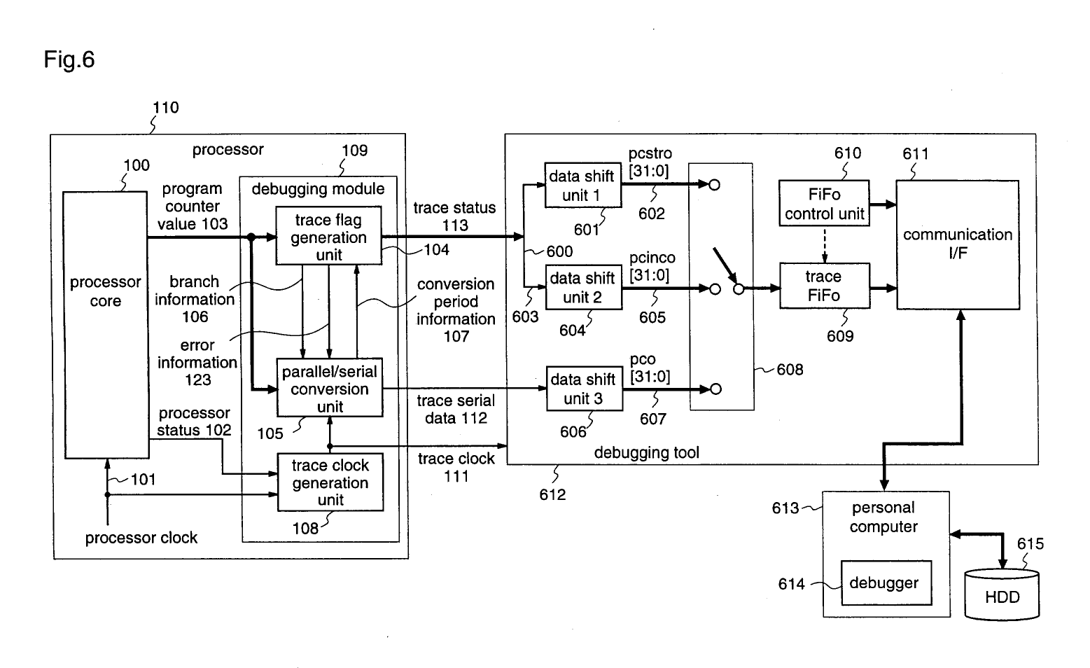

FIG. 6 is a block diagram illustrating a structure of a PC trace system according to a second embodiment of the present invention. In FIG. 6, respective functions of components 100 to 113 and 123 are the same as those of the first embodiment. The PC trace system according to the second embodiment includes a first data shift unit 601 for converting a first trace status 600 into parallel data to output first parallel output data 602; a second data shift unit 604 for converting a second trace status 603 into parallel data to output second parallel output data 605; a third data shift unit 606 for converting trace serial data 112 into parallel data to output third parallel output data 607; a data selection unit 608 for successively selecting one of the first parallel data 602, the second parallel data 605, and the third parallel data 607 to store the selected parallel data in a trace FiFo 609; a trace FiFo 609 for storing the parallel data selected by the data selection unit 608; a FiFo control unit 610 for controlling writing/reading of data into/from the trace FiFo 609 and capacity information; a communication interface 611 for transferring the parallel data that is stored in the trace FiFo 609 in accordance with an instruction from the computer while the processor is operating; a computer 613 for operating a debugger 614 that implements program counter trace; a large capacity hard disk 615 for storing parallel data which is read from the trace FiFo 609; and a debugger 614 for restoring an original program counter value from the parallel data which is read from the trace FiFo 609 via the communication I/F 611 and analyzing the operation of the processor in combination with a source code of a program which is being executed by the processor.

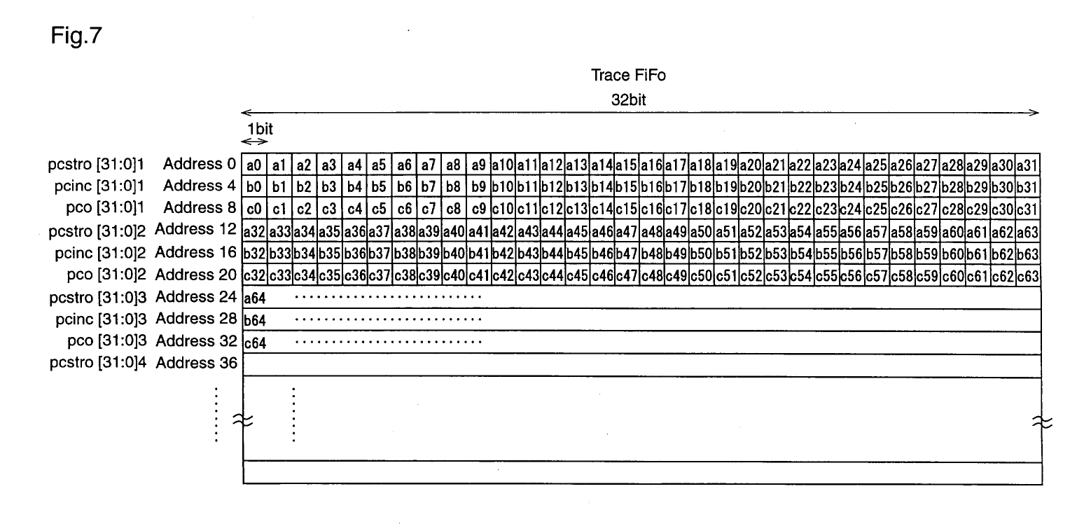

FIG. 7 is a diagram showing a state of storage of the parallel data which are stored in the trace FiFo 609 in FIG. 6. In this figure, “a0”, “a1”, . . . denote the signal numbers of the trace status 1 in FIG. 3, “b0”, “b1”, . . . denote the signal numbers of the trace status 2 in FIG. 3, and “c0”, “c1”, . . . denote the signal numbers of the trace data in FIG. 3, respectively. Address numbers on the left end show RAM addresses at a time when the trace FiFo 609 is constituted by a RAM, each address of which comprises 8 bits.

An operation of the PC trace system that is constructed as described above will be described hereinafter.

In FIG. 6, the debugging tool 612 stores the trace status 113 and the trace serial data 112 which are outputted by the processor 110, in the FiFo 609 in the manner as shown in FIG. 7, in the order of: 32-bit first trace status, 32-bit second trace status, and then 32-bit trace serial data. In this second embodiment, the trace memory that is used in the first embodiment is replaced with the trace FiFo, thereby enabling the computer to keep track of the capacity of the trace FiFo. The trace FiFo includes two kinds of ports: a writing port and a reading port, so that a writing operation and a reading operation can be simultaneously performed. Thus, the computer 613 reads the trace status and the trace data from the trace FiFo 609 unless the trace FiFo 609 is empty on the basis of the trace FiFo capacity information indicated by the FiFo control unit 610, and stores the read trace status and trace data in the large capacity hard disk 615 in the computer. Then, when the operation of the processor is stopped, the computer 613 restores the program counter value from the trace status and trace data which are stored in the large capacity hard disk 615, and performs analysis of the program in the debugger 614.

As described above, according to the second embodiment, the debugging tool includes the first data shift unit 601 that converts the first trace status information into parallel data; the second data shift unit 604 that converts the second trace status information into parallel data; the third data shift unit 606 that converts the trace serial data into parallel data; the data selection unit 608 that successively selects one of the parallel output data 602 which is outputted from the first data shift unit 601, the parallel output data 605 which is outputted from the second data shift unit 604, and the parallel output data 607 which is outputted from the third data shift unit, and outputs the selected parallel output data; the trace FiFo 609 that stores the parallel output data which is selected by the data selection unit 608; and the FiFo control unit 610 that outputs the capacity information of the trace FiFo 609 and controls the writing/reading capacity information for the trace FiFo. Therefore, the parallel trace data which are read from the trace FiFo via the communication interface according to the capacity information of the trace FiFo control unit are stored in the large capacity hard disk of the computer, whereby the debugging tool can employ a smaller capacity of storage means.

Embodiment 3.

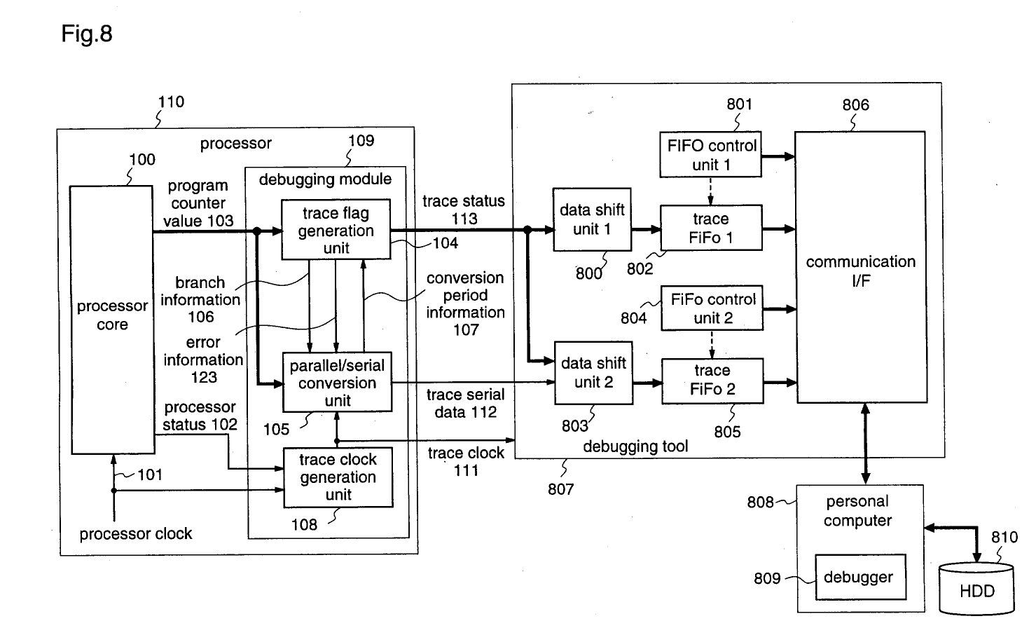

FIG. 8 is a block diagram illustrating a structure of a PC trace system according to a third embodiment of the present invention. In FIG. 8, respective functions of components 100 to 113 and 123 are the same as those in the first embodiment. The PC trace system according to the third embodiment includes a first data shift unit 800 for converting the trace status 113 into parallel data; a first trace FiFo 802 for storing parallel output data from the first data shift unit 800; a first FiFo control unit 801 for controlling writing/reading of data into/from the first trace FiFo 802 and capacity information; a second data shift unit 803 for converting the trace serial data into parallel data only when the two kinds of trace status information shows an effective trace serial data output period; a second trace FiFo 805 for storing parallel output data from the second data shift unit 803; a second FiFo control unit 804 for controlling writing/reading of data into/from the second trace FiFo 805 and capacity information; a communication interface 806 for transferring first parallel data stored in the first trace FiFo 802 and second parallel data stored in the second trace FiFo 805 in accordance with an instruction from the computer while the processor is operating; a computer 807 for operating a debugger 808 that implements program counter trace; a large capacity hard disk 809 for storing the first parallel data read from the first trace FiFo 802 and the second parallel data read from the second trace FiFo 805 separately in different files; and a debugger 808 for restoring the second parallel data to a program counter value on the basis of status information of the first parallel data which is read from the first trace FiFo 802 via the communication I/F 806, and analyzing the operation of the processor in combination with a source code of the program which is being executed by the processor.

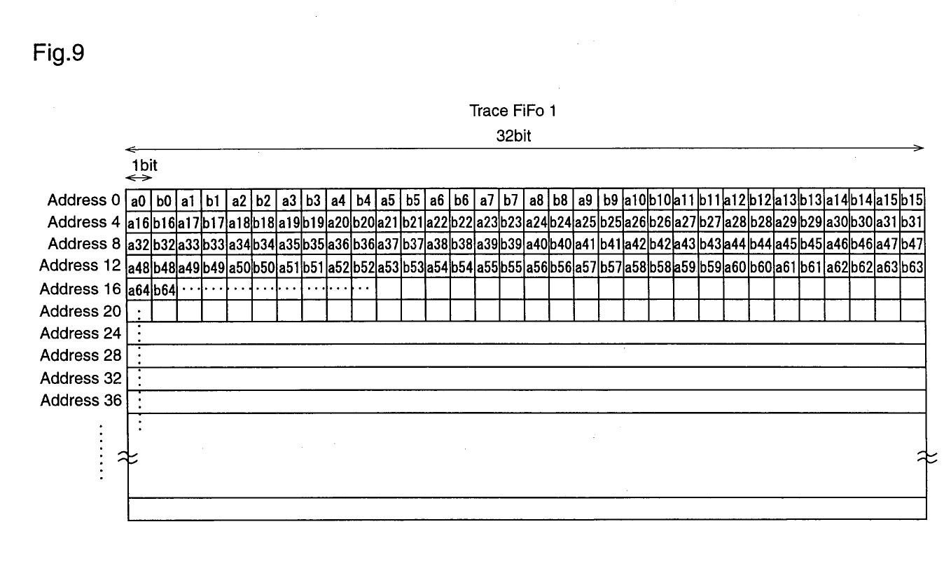

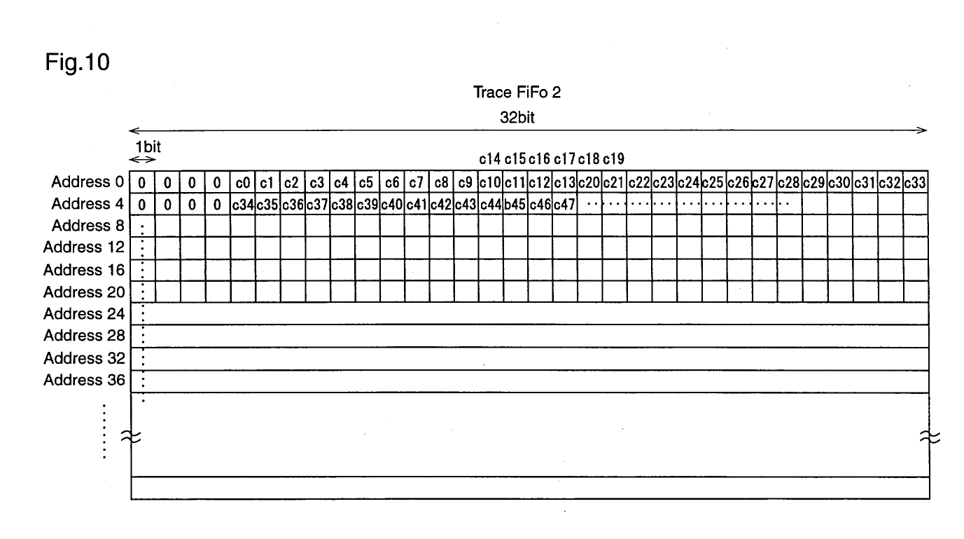

FIG. 9 is a diagram showing a state of storage of parallel trace data which are stored in the first trace FiFo 802 in FIG. 8. FIG. 10 is a diagram showing a state of storage of parallel trace data which are stored in the second trace FiFo 805 in FIG. 8. In these figures, “a0”, “a1”, . . . denote the signal numbers of the trace status 1 in FIG. 3, “b0”, “b1”, . . . denote the signal numbers of the trace status 2 in FIG. 3, and “c0”, “c1”, . . . denote the signal numbers of the trace data in FIG. 3, respectively.

An operation of the PC trace system that is constructed as described above will be described hereinafter.

In FIG. 8, the trace status 113 which is outputted by the processor 110 is stored in the first trace FiFo 802 in a manner as shown in FIG. 9, with a first trace status and a second trace status being paired. The first trace status and the second trace status at the same timing are stored in the same stage of the trace FiFo. In addition, the trace serial data 111 which are outputted from the processor 110 are stored in the second trace FiFo 805 in a manner as shown in FIG. 10 only when the trace status 113 indicates an effective trace serial data output period, i.e., by the number of bits corresponding to the program counter value (14 bits) from a timing when pcstr is “11” and pcinc is “0”. In the second trace FiFo 805, trace data corresponding to two cycles (28 bits) are stored in each stage of the trace FiFo (32 bits) such that 14-bit trace data do not spread over two stages of the trace FiFo. The computer 808 reads the trace status and the trace data from the trace FiFos 802 and 805 when the trace FiFos 802 and 805 are not empty on the basis of the trace FiFo capacity information indicated by the FiFo control units 801 and 804, and stores the read trace status and trace data in the large capacity hard disk 810 of the computer. Then, when the operation of the processor is stopped, the computer 808 restores the program counter value from the trace status and the trace data which are stored in the large capacity hard disk 810, and performs analysis of the program in the debugger 809.

As described above, according to the third embodiment, the debugging tool 807 includes the first data shift unit 800 that converts the first and second trace status information into parallel data; the first trace FiFo 802 that stores the parallel output data from the first data shift unit 800; the first FiFo control unit 801 that outputs the capacity information of the first trace FiFo 802 and controls the writing/reading of data into/from the first trace FiFo; the second data shift unit 803 that converts the trace serial data into parallel data only when the first and second trace status information indicates an effective trace serial data output period; the second trace FiFo 805 that stores the parallel output data from the second data shift unit 803; and the second FiFo control unit 804 that outputs the capacity information of the second trace FiFo 805 and controls writing/reading of data into/from the second trace FiFo, and further the second trace FiFo stores only necessary trace information. Therefore, the amount of information stored in the trace FiFo can be reduced, and accordingly the capacity of the trace FiFo can be reduced.

Embodiment 4.

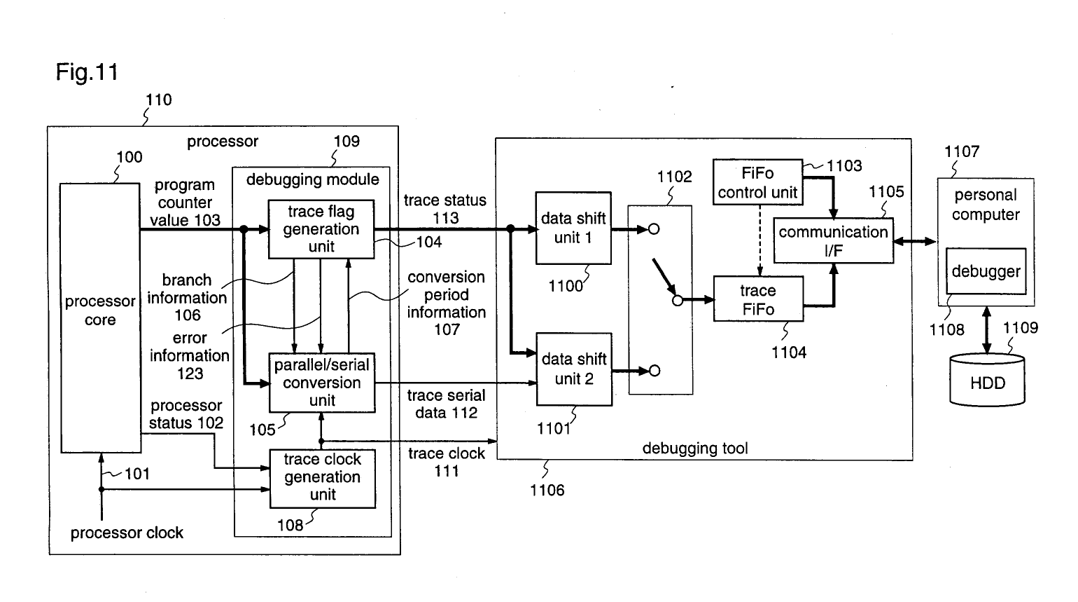

FIG. 11 is a block diagram illustrating a structure of a PC trace system according to a fourth embodiment of the present invention. In FIG. 11, respective functions of components 100 to 113 and 123 are the same as those in the first embodiment. The PC trace system according to the fourth embodiment includes a first data shift unit 1100 for converting the trace status 113 into parallel data with alternately arranging a first trace status and a second trace status, and further adding thereto a flag indicating that the parallel data is trace status information to output first parallel output data; a second data shift unit 1101 for converting the trace serial data into parallel data, and further adding thereto a flag indicating that the parallel data is trace serial data to output second parallel output data only when the two kinds of trace status information indicate an effective trace serial data output period; a data selection unit 1102 for selecting data when 32-bit parallel output data is completed in the first data shift unit 1100 or the second data shift unit 1101, and storing the selected data in a trace FiFo 1104; a trace FiFo 1104 that holds the parallel output data which is selected by the data selection unit 1102; a FiFo control unit 1103 for controlling writing/reading of data into/from the trace FiFo 1104 and capacity information; a communication interface 1105 for transferring the parallel output data which is stored in the trace FiFo 1104 in accordance with an instruction from the computer while the processor is operating; a computer 1107 for operating a debugger 1108 that implements program counter trace; a large capacity hard disk 1109 for storing the parallel output data which is read from the trace FiFo 1104 in a file; and a debugger 1108 for judging the flag of the parallel output data which is read from the trace FiFo 1104 via the communication I/F 1105 to extract status information, restoring parallel data which is extracted from a flag indicating the trace serial data on the basis of the extracted trace status information into a program counter value, and analyzing the operation of the processor in combination with a source code of the program which is being executed by the processor.

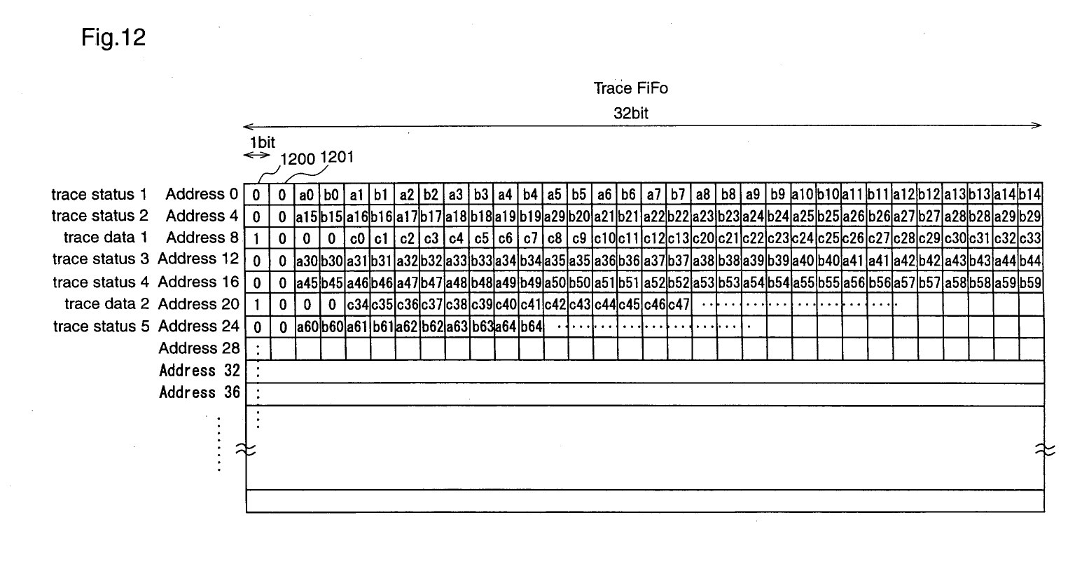

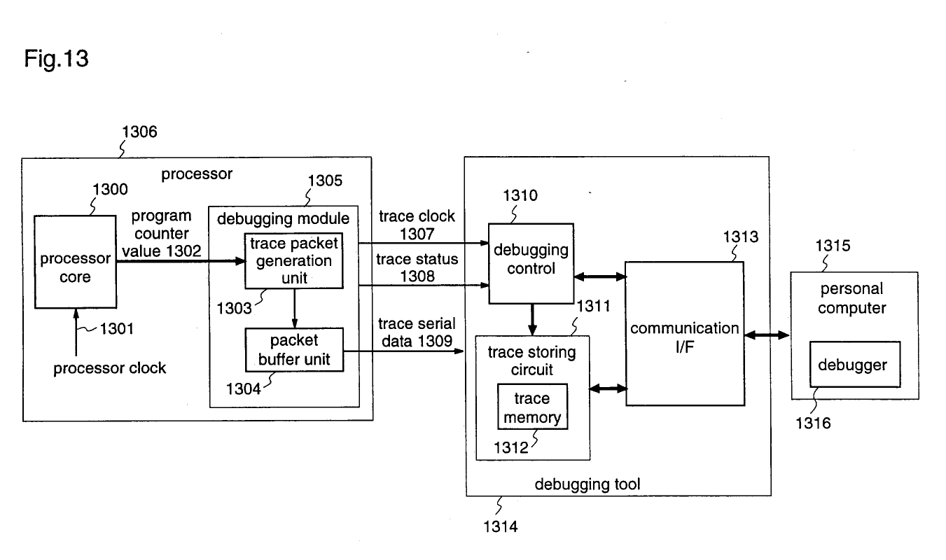

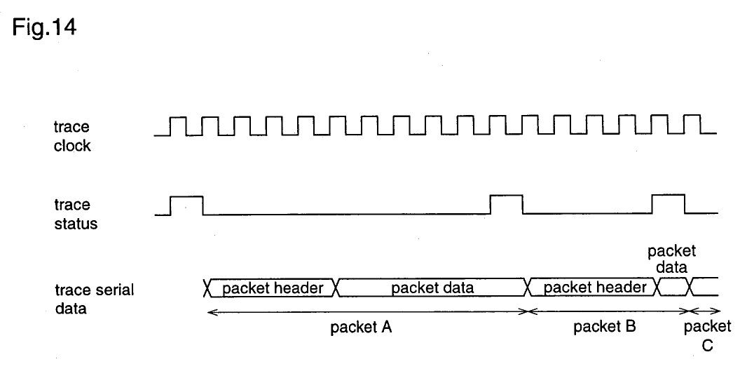

FIG. 12 is a diagram illustrating a state of storage of parallel trace data which are stored in the trace FiFo 1104 in FIG. 11. In this figure, “a0”, “a1”, . . . denote the signal numbers of the trace status 1 in FIG. 3, “b0”, “b1”, . . . denote the signal numbers of the trace status 2 in FIG. 3, and “c0”, “c1”, . . . denote the signal numbers of the trace data in FIG. 3.

In FIG. 12, numeral 1200 denotes a flag indicating whether parallel data is trace status information or trace serial data. In this case, “0” indicates trace status information, and “1” indicates trace serial data. In addition, numeral 1201 denotes a bit area that complements shortage of 32 bits. These areas are unused areas and “0” is inputted here to all of these areas, but “1” may be inputted thereto.

An operation of the PC trace system that is constructed as described above will be described hereinafter.

In FIG. 11, the trace status 113 that is outputted from the processor 110 is stored in the trace FiFo 1104 in a manner as shown in FIG. 12, with the first or second parallel output data being stored according to the order in which the parallel conversion into 32 bits has been completed. The first trace status and the second trace status at the same timing are stored in the same stage of the trace FiFo. Further, trace data corresponding to two cycles (28 bits) are stored in each stage (32 bits) of the trace FiFo such that trace data of 14 bits do not spread over two stages of the trace FiFo. The computer 1107 reads the trace status and the trace data from the trace FiFo 1104 when not the trace FiFo 1104 on the basis of the trace FiFo capacity information indicated by the FiFo control unit 1103, and stores the read trace status and trace data in the large capacity hard disk 1109 of the computer. Then, when the operation of the processor is stopped, the computer 1107 restores the program counter value from the trace status and trace data which are stored in the large capacity hard disk 1109, and performs analysis of the program in the debugger 1108.

As described above, according to the fourth embodiment, the debugging tool includes the first data shift unit 1100 that converts the first and second trace status information into parallel data and further adds to parallel data a flag indicating that the parallel data is trace status information; the second data shift unit 1101 that converts trace serial data into parallel data and further adds to the parallel data a flag indicating that the data is trace serial data, only when the first and second trace status information indicates an effective trace serial data output period; the data selection unit 1102 that selects parallel output data which is outputted from the first data shift unit 1100 when the parallel conversion of the first data shift unit 1100 has been completed, while selecting parallel output data which is outputted from the second data shift unit 1101 when the parallel conversion of the second data shift unit 1101 has been completed; the trace FiFo 1104 that stores the parallel output data which is selected by the data selection unit 1102; and the FiFo control unit 1103 that outputs capacity information of the trace FiFo 1104 and controls writing/reading of data into/from the trace FiFo. Therefore, the trace status information and necessary trace serial data can be stored in one trace FiFo, whereby the number of trace FiFos which are mounted on the debugging tool can be reduced as well as the capacity of the trace FiFo can be reduced.

### INDUSTRIAL AVAILABILITY

According to the program counter trace system of the present invention, in cases where an external debugging tool and a processor are operated at the same frequency, trace information can be outputted from the processor to the external debugging tool through fewer external terminals, and it is not required to mount a memory such as a packet buffer on the processor, whereby chip costs and power consumption can be reduced and, it is greatly useful particularly in the field of debugging for processors.

1. A program counter trace system which operates a processor and an external debugging tool at a same frequency to perform program counter trace for debugging, wherein
the processor includes:
a trace flag generation unit for holding a program counter value which is outputted from a processor core that executes a program in each operation cycle of the processor, obtaining a difference between a previous program counter value which is held and a present program counter value, and generating on the basis of the difference in each cycle, first and second trace status information indicating that a present status is one of: a status corresponding to a head of serial data of a program counter value; a status in which displacement from the previous program counter value is “0”; a status in which displacement from the previous program counter value is “1”; and an error occurrence status indicating that serial data outputting occurs in a period which overlaps an output period of the serial data, and branch information indicating that the program counter value is branched;
a parallel/serial conversion unit for converting a program counter value into serial data only when the branch information generated by the trace flag generation unit indicates a branch status, and outputting the serial data as trace serial data; and
a trace clock generation unit for outputting a trace clock having the same frequency as that of an operation clock for the processor, and
the debugging tool receives the trace status information and the trace serial data in synchronization with the trace clock.

2. The program counter trace system of claim 1 wherein
the processor includes a control means for controlling the trace flag generation unit, the parallel/serial conversion unit, and the trace clock generation unit to operate only when the processor core is operating in a debugging mode, while stopping operations of the trace flag generation unit, the parallel/serial conversion unit, and the trace clock generation unit when the processor is stopping in the debugging mode or in cases other than the debugging mode.

3. The program counter trace system of claim 1 wherein
the debugging tool includes:
a first data shift unit for converting the first trace status information into parallel data;
a second data shift unit for converting the second trace status information into parallel data;
a third data shift unit for converting the trace serial data into parallel data;
a data selection unit for successively selecting one of the parallel output data which is outputted from the first data shift unit, the parallel output data which is outputted from the second data shift unit, and the parallel output data which is outputted from the third data shift unit, and outputting the selected parallel output data;
a trace FiFo for storing the parallel output data which is selected by the data selection unit; and
a FiFo control unit for outputting capacity information of the trace FiFo and controlling writing/reading capacity information of the trace FiFo.

4. The program counter trace system of claim 1 wherein
the debugging tool includes:
a first data shift unit for converting the first and second trace status information into parallel data;
a first trace FiFo for storing the parallel output data from the first data shift unit;
a first FiFo control unit for outputting capacity information of the first trace FiFo and controlling writing/reading of data into/from the first trace FiFo;
a second data shift unit for converting the trace serial data into parallel data only when the first and second trace status information indicates an effective trace serial data output period;
a second trace FiFo for storing the parallel output data from the second data shift unit; and
a second FiFo control unit for outputting capacity information of the second trace FiFo and controlling writing/reading of data into/from the second trace FiFo.

5. The program counter trace system of claim 1 wherein
the debugging tool includes:
a first data shift unit for converting the first and second trace status information into parallel data, and further adding to the parallel data a flag indicating that the parallel data is trace status information;
a second data shift unit for converting the trace serial data into parallel data and adding thereto a flag indicating that the parallel data is trace serial data, only when the first and second trace status information indicates an effective trace serial data output period;
a data selection unit for selecting the parallel output data from the first data shift unit when the parallel conversion of the first data shift unit has been completed, while selecting the parallel output data from the second data shift unit when the parallel conversion of the second data shift unit has been completed;
a trace FiFo for storing the parallel output data which is selected by the data selection unit; and
a FiFo control unit for outputting capacity information of the trace FiFo and controlling writing/reading of data into/from the trace FiFo.

6. A program counter trace method for operating a processor and an external debugger tool at a same frequency, and performing program counter trace for debugging, in which:
the processor holds a program counter value which is outputted from a processor core that executes a program in each operation cycle of the processor, obtains a difference between a previous program counter value that is held and a present program counter value, and generates on the basis of the difference in each cycle, first and second trace status information indicating that a present status is one of: a status corresponding to a head of serial data of a program counter value; a status in which displacement from the previous program counter value is “0”; a status in which displacement from the previous program counter value is “1”; and an error occurrence status indicating that serial data outputting occurs in a period that overlaps an output period of the serial data, and branch information indicating that the program counter value is branched;
the processor converts a program counter value into serial data only when the generated branch information indicates a branch status, and outputs the serial data as trace serial data;
the processor outputs a trace clock having the same frequency as that of an operation clock of the processor; and
the debugging tool receives the trace status information and the trace serial data in synchronization with the trace clock.

7. A semiconductor device which has a processor including a processor core that executes a program, wherein
the processor includes:
a trace flag generation unit for holding a program counter value which is outputted from the processor core that executes the program in each operation cycle of the processor, obtaining a difference between a previous program counter value that is held and a present program counter value, and generating on the basis of the difference in each cycle, first and second trace status information indicating that a present status is one of: a status corresponding to a head of serial data of the program counter value; a status in which displacement from the previous program counter value is “0”; a status in which displacement from the previous program counter value is “1”; and an error occurrence status indicating that serial data outputting occurs in a period that overlaps an output period of the serial data, and branch information indicating that the program counter value is branched;
a parallel/serial conversion unit for converting a program counter value into serial data only when the branch information which is generated by the trace flag generation unit indicates a branch status, and outputting the serial data as trace serial data; and
a trace clock generation unit for outputting a trace clock having the same frequency as that of an operation clock of the processor.
